(19) United States
(12) Patent Application Publication
(10) Pub. No.: US 2010/0057273 A1
(43) Pub. Date: Mar. 4, 2010

(54) Screen-Based Vehicle Control System

(75) Inventors: Rainer Heers, Koln (DE); Thomas Sulzbach, Koln (DE); Bertrand Stelandre, Thimister (BE)

Correspondence Address: DICKINSON WRIGHT PLLC, 1875 Eye Street, NW, Suite 1200, WASHINGTON, DC, 20006, US

(73) Assignee: VISTEON GLOBAL TECHNOLOGIES, INC., Van Buren Township, MI (US)

(21) Appl. No.: 12/548,663

(22) Filed: Aug. 27, 2009

(30) Foreign Application Priority Data
Aug. 28, 2008 (DE) 10 2008 041 649.5

(51) Int. Cl. G06F 19/00; G06F 3/041

(52) U.S. Cl. 701/1; 345/173

(57) ABSTRACT

A screen-based vehicle control system in which the control arrangement (1) consists of a screen (2) and at least one mechanical control unit (3). The mechanical control unit is disposed to project at least in part into the display field of the screen and may be implemented such that relative positions or scales of the control unit my be represented on the screen.

### CROSS REFERENCE TO RELATED APPLICATION

This application claims the benefit of German Patent Application No. 10 2008 041 649.5-34 filed Aug. 28, 2008, entitled “Screen-Based Vehicle Control System,” the entire disclosure of this application being incorporated by reference.

### BACKGROUND OF THE INVENTION

1. Technical Field

The present invention is directed to a screen-based vehicle control system.

2. Discussion

Screen-based vehicle control systems may control a vehicle and various vehicle components. More specifically, screen-based vehicle control systems fulfill the function of a man-machine interface and transfer the control commands of a user to the vehicle and to individual controllable components of a vehicle.

Many automobile manufacturers install touch-sensitive screens (touch screens) in the vehicle compartment to achieve simple, intuitive operation of multifunction systems. These multifunction systems make access and control possible for various functions of the multi-function systems that are built into the vehicle (in particular, radio and audio systems, navigation, air-conditioning and heating equipment, vehicle adjustments, driver information and assistance systems). Recently, more and more of these multi-function systems also provide access and control capabilities for mobile terminal equipment (for example, mobile telephones, portable navigation instruments, PDA's and notebooks/laptops).

In actual development of control and display designs for multi-function systems, the ergonomic and software-ergonomic considerations, in particular, play a role in facilitating the safe operation of complex systems while driving (cf., for example, ISO DIN 15008, ISO DIN 17287, ISO DIS 26022, as well as the ergonomic guidelines “European Statement of Principles” (ESoP) of the European Union, the US Alliance of Automobile Manufacturers (AAM) guidelines “AAM Guideline”, and the Japanese Automobile Manufacturers Association (JAMA) guidelines “JAMA Guidelines”.

A multifunction system with a touch-sensitive screen as an input and output device is customarily attached or placed in the center console of the vehicle compartment. The user can then trigger the desired function by touching one of the control units directly. Examples are found, among other places, in various systems in vehicles from Ford, Volkswagen, or Toyota.

In some cases, additional control units are found in the immediate vicinity of a touch-sensitive or touch-insensitive screen, which are used to make additional control options available. The display of the function to be controlled as well as the status of the same then appears on the screen. On technical grounds, these control units have up to now been attached at some distance from the screen.

Vehicle control systems have limited available space on the instrument panel and designers must consider this limited available space as well as tactile habits of the operator which are taken into consideration, and by the application of modern developments in control and automation technology.

In EP 1383035 A2, a control and display system is described for use in a vehicle. This control and display system consists of a screen, on which the control units are arranged and divided into several sections, as well as a related control panel on which switches are arranged and also divided into several sections. The system uses ten keys outside the display to make the input of telephone numbers possible. In addition, the illustration of a control unit on the screen is described and illustrated in FIG. 8 or FIGS. 33-37 in EP 1383035 A2. Furthermore, the manner is depicted in which assignment of control units can take place on a vertically disposed control panel beneath the screen with their displays represented on the screen above it. It is a disadvantage that the direct assignment and overlay of a screen with control units does not occur in EP 1383035 A2.

In U.S. Publication Serial No. 2005/0140661 A1, mobile terminal equipment, a PDA (personal digital assistant), is described, which includes the display, on a touch-sensitive screen, of the contents and the allocation of control units, as well as some further control units at the lower edge of the equipment. It is also described that the control units are disposed in the vicinity of the edge of the screen. It proves to be disadvantageous that close interaction of control units with the touch-sensitive screen is not provided. The operation takes place either through the control units in the vicinity of the screen edge or through the touch-sensitive screen by itself.

In U.S. Publication Serial Nos. 2003/0080947 A1, 2003/0081015 A1, and 2003/0081016 A1, a mobile terminal device is described in each, which includes content and control units on a touch-sensitive screen, as well as further control units in a different arrangement for controlling and adjusting the contents on the screen. These control units are arranged below the screen. The U.S. Publication Serial Nos. 2005/0140661 A1, 2003/0080947 A1, 2003/0081015 A1, and 2003/0081016 A1, all have the disadvantage that no direct assignment and overlay of a screen with control units occurs.

In the patent DE 10 2004 037 644 A1, a touch-sensitive screen is described for installation in a vehicle, which is characterized in particular by a separate, deformable protective surface and is suitable for using push buttons on this surface. The embodiments described in DE 10 2004 037 644 A1 concern respective display and control units which are represented and controlled on the screen. Here the disadvantage is that the display and control units are displayed only on the touch-sensitive screen. Direct assignment and overlay with conventional control units is not provided, which brings with it tactile advantages.

The patent DE 101 396 92 A1 describes a multifunction system for installation in a vehicle, whereby it consists of a control unit as well as a conventional screen which is not made touch-sensitive. The control unit is executed in the shape of a cylinder. The problem with a screen which is not made touch-sensitive is that it cannot achieve sufficient flexibility for the depiction of different functions and their adjustment by the operator.

In the patent DE 101 396 93 A1, various alternatives are described with regard to the position and implementation in the center console of a vehicle. In particular, pages 2 and 3 and FIG. 1 of DE 101 396 92 A1 show that not one direct assignment and overlay of a screen with (classic) control units will result hereby.

Likewise, display and control units are described in DE 101 396 93 A1 which present the disadvantage that no direct assignment and overlay of a screen with conventional control units takes place and the control of the functions does not occur in the advantageous, tactilely comparable manner with the conventional control units.

In spite of many and various optimization trials, disadvantages exist in the known designs for touch-sensitive screens in a vehicle, in that these do not make possible to a sufficient degree the ergonomically optimized and integrated operation and display of functions and applications that is appropriate for the particular conditions of operating a system while driving.

In some cases, additional control elements are attached around the screen which allows the control units to flexibly assign the functions displayed on the screen. The distance provided up to now from additionally attached control units to the screen can, however, lead at the same time to the driver incorrectly assigning the control units to functions or, in correctly assigning them, taking a relatively long time for this to look inside the vehicle. In particular, a longer glance away from the traffic may represent a potentially hazardous situation while driving, which is to be avoided or minimized if possible.

Further disadvantages and deficiencies are (1) only the functions and their status are visible which are available in the main-menu area just selected; (2) the display possibilities are limited by the size of the screen; and (3) flexibility lacking in the assignment of functions to the control units and therewith a limited range of controllable functions with conventional control units with a fixed, assigned function.

### SUMMARY OF THE INVENTION

The invention is for that reason based on the problem of the invention teaching a procedure and a device in general terms such that the adaptability missing from a conventional mechanical control unit is overcome, but retaining its advantageous tactile properties.

The problem is resolved by a screen-based vehicle-control system such that the control arrangement includes a screen and at least one mechanical control unit. The screen is executed in an advantageous embodiment as a touch-sensitive screen.

At the same time, at least one control unit is disposed such that it projects in part up into the variable display field of the screen and covers it to that extent. The variable display field of the screen depicted is executed such that a scale can be represented adjoining the control unit. In addition, at least one control unit is executed as a twist control or alternatively as a push button or as a sensor unit. In addition, a mechanical transfer element is laid out so that the control unit acts on the electromechanical unit above it.

The screen and the control unit are advantageously teaching, laid out such that they are provided with proximity sensors and lighting units and illumination occurs upon moving toward it.

The screen is executed in such a manner that at least two contacts, by the user and by a control element projecting up above the screen, can be recorded independently of one another.

The following advantages are associated with the control arrangement according to the invention.

The advantage of the invention lies in particular in the possibility of achieving in an optimized manner a consistent and easily controllable control and display design for a control system. Such a control and display design includes an arrangement of control units around a touch-sensitive screen in the area of the center console of a vehicle in a position ergonomically favorable for the driver and passenger. Thus it is possible, through the selection, layout, and arrangement of the control units, to fashion a display design that facilitates ergonomically optimized operation at the central information screen, and to extend the well-known WYSIWYG principle (“what you see is what you get”) here from software ergonomy in an improved vehicle-specific form. In particular, it is possible to bring about a clear relationship between pressing the control units and what happens on the touch-sensitive screen.

A further advantage for the automobile manufacturer, which is not to be underestimated, lies in the option of being able herewith to install a further alternative control system in order to design, shape, and realize a brand-typical control and display design.

The control system, as set forth by the invention represented here, offers, through a suitable layout and composition of control units (control design, consisting here of a touch-sensitive screen as well as further control units), as well as displays on the screen (display design), to bring about a clear relationship between the operation and the display of functions on a touch-sensitive screen as well as its surrounding control elements.

In the invention, the control units are disposed either directly underneath the screen or projecting above it. A direct spatial relationship is hereby always created between the display on the screen and the accompanying control units. Consequently, mistakes in assignment and operation are substantially avoided, and the operation is made easier altogether. This leads, particularly in a driving situation, to less turning away from the traffic situation.

The space-saving arrangement of the control units in the immediate vicinity of the touch-sensitive screen produces spatial advantages which can be used either to provide a larger screen or to save weight or to make space for other equipment.

### BRIEF DESCRIPTION OF THE DRAWINGS

Further particulars, characteristics, and advantages of the invention arise from the following description of embodiment examples with reference to the accompanying drawings. Shown are:

FIG. 1 shows a control arrangement with control units at the lower edge;

FIG. 2 shows a control arrangement with control units at the side edges;

FIG. 3 shows a control arrangement with control units at the upper and lower edge;

FIG. 4 shows a control arrangement with buttons as control units;

FIG. 5 shows a side view of the control arrangement with twist controls;

FIG. 6 shows a side view of the control arrangement with extended and eccentrically positioned twist controls;

FIG. 7 shows a side view of the control arrangement with a sensor unit; and

FIG. 8 shows a side view of the control arrangement with buttons.

### DETAILED DESCRIPTION OF THE PREFERRED EMBODIMENT

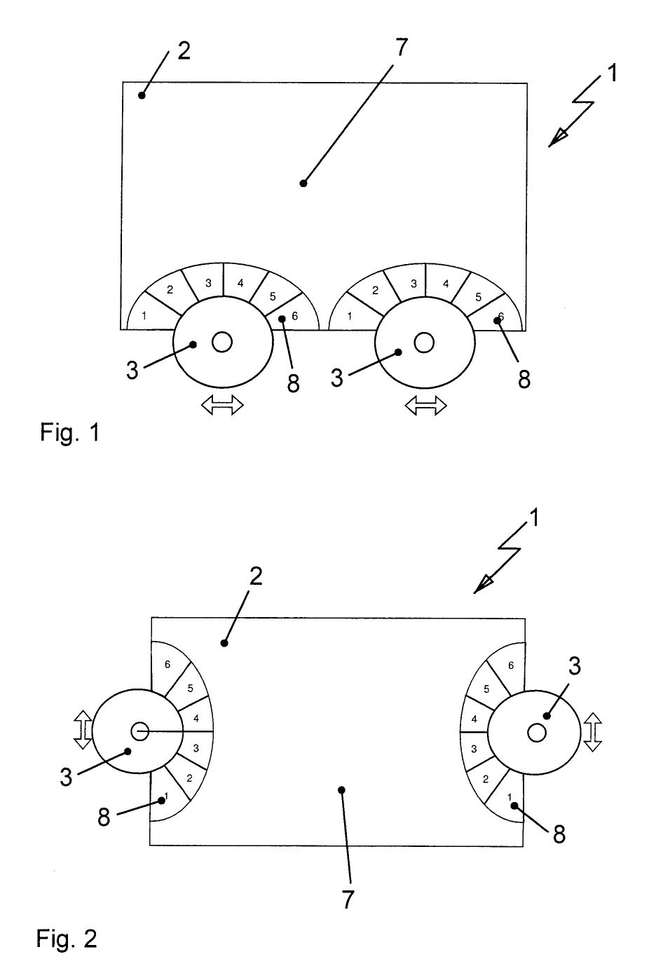

FIG. 1 shows a control arrangement 1, which exhibits a screen 2, on the surface of which the variable display field 7 is found. A portion of this variable display field 7 is used as a graduated control scale 8. The control scale 8 is disposed in the immediate vicinity of the control units 3. The control units 3 project up onto the surface of the screen 2 and consequently into the variable display field.

The control units 3 illustrated in FIGS. 1-3 are constructed as twist controls and are above the surface of the screen 2; however, the control units 3 may alternatively be twist-push controls for operation. Consequently, the control units 3 are readily touchable by the operator and offer the tactile advantage of a conventional mechanical control unit. The control scale 8, which extends into the variable display field 7, is flexibly manipulatable, so that one and the same control unit 3 can control different functions. The control scale 8, appropriately flexible and current, is changed to control different functions through screen control. More specifically, the associated functions or selections related to the control units 3 are projected on the screen 2 and move in coordination with the control units 3.

Above the control scale 8 in the variable display field 7 are found the display areas of the variable display field 7, on which the further tasks for a current function of the vehicle and its assemblies and structural components are represented by special functions or associated values.

In a preferred embodiment, the screen 2 is executed such that two or more contacts at the same time, by the user or by a control unit 3 projecting up above it, can be recorded independently. Moreover, in a further preferred embodiment of the invention, the control arrangement 1 is equipped with proximity sensors and lighting units, in order to make possible front or back lighting of the control units or the screen when coming up close, specifically when the user is close to it or approximately in a position to interact with it.

FIG. 2 also shows a control arrangement 1, which consists of a screen 2 and two control units 3. Here, the two control units 3 are also constructed as twist controls; however they are disposed at the side of the screen 2. The control units 3 project above the side border of the screen 2 over into the variable display field 7. The control units 3 are laid out at the edge of the screen 2.

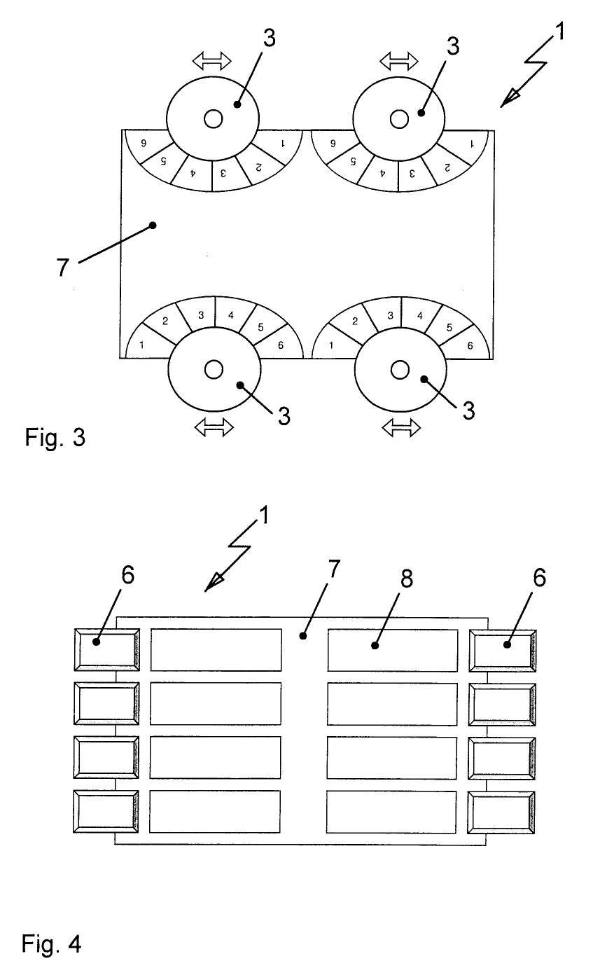

FIG. 3 depicts a control arrangement 1 in which four control units 3 are used. Each of the four control units 3, which are attached to the upper and lower edge of the screen 2, project above the upper and lower boundary of the screen 2 over into the variable display field 7. Above each of the four control units 3 is its own control scale 8, each of which is displayed in the variable display field 7. A varying display is represented, as required, on the control scale 8 through the control menu. Of course, the size, position, number of buttons or control units 3, style and display area may vary depending on the desired functions, style or other characteristics, without departing from the spirit of the invention.

FIG. 4 depicts a control arrangement 1 with key- or button-type control elements such as the illustrated push buttons 6. FIG. 4 illustrates four push buttons 6 that are disposed at the right and left edge respectively of the screen 2. Although not illustrated, in an alternative arrangement, the push buttons 6 are disposed on the upper and lower edge. The buttons 6 project above the border of the screen 2 over into the variable display field 7. They may alternatively be also disposed beneath the touch-sensitive screen 2. On the variable display field 7, the control scale 8 is depicted, which displays the function assigned to the respective push button 6. As a result of the ability to variably represent the control scale 8 on the screen 2, different functions can be assigned as required to the buttons 6, which are given in the menu layout. The push buttons 6 exhibit the advantages of a mechanical control unit, are touchable by the operator, and possess the same tactile properties as a conventional mechanical control unit. The flexibility with regard to the control function, however, is suited to a touch-sensitive screen with flexible, adaptable display and control possibilities.

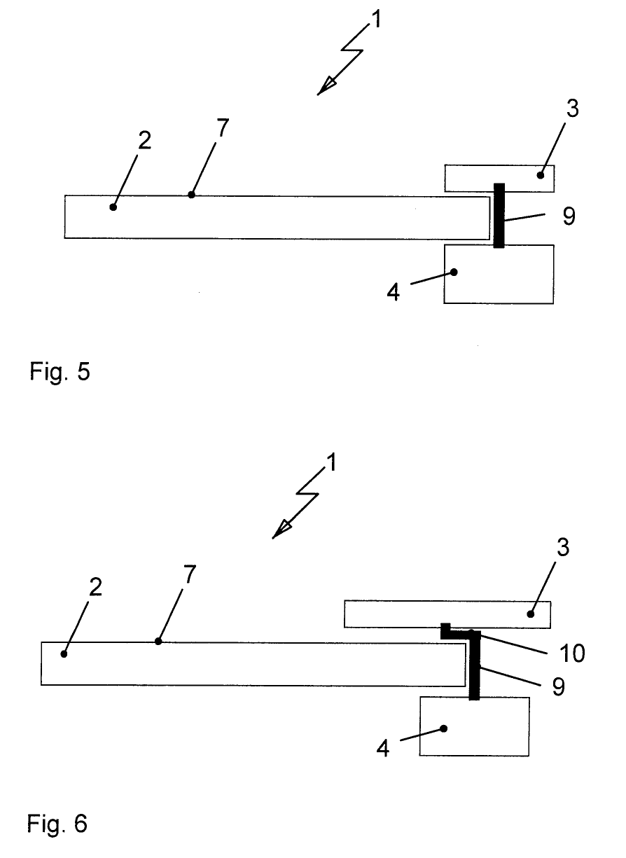

FIG. 5 depicts the control arrangement 1 in a side view. The control arrangement 1 represented in FIG. 5 corresponds to the control arrangement 1 represented in one of FIG. 1, 2, or 3. The control unit 3 is discernible, which with its radius projects over the outer lateral boundary of the screen 2 and covers a portion of the variable display field 7. The control unit 3 is connected mechanically to the electromechanical unit 4. This connection occurs through the mechanical transfer element 9. This is exemplary executed as a shaft in the embodiment example represented in the Figures. The electromechanical unit 4 changes the mechanical energy, which is impressed by the operator onto the control element 3, into an electrical signal. This conversion can take place according to various known principles. So, with the electromechanical unit 4, we could be dealing with a variable resistance, a variable capacitance, or a variable inductance. In exactly the same way, conversion to a digital signal is possible, in which the angle of rotation of the control unit 3 is converted to a corresponding discrete value.

FIG. 6 shows the control arrangement 1, in which a particularly large control unit 3 is disposed on the screen 2 with the variable display field 7, executed as twist controls or alternatively executed as twist-push controls. Here the control unit 3 covers a large area of the variable display field 7, as a result of which the display possibilities are expanded through the control scale 8. The control unit 3 is connected by means of the mechanical transfer unit 9 to the electromechanical unit 4. The mechanical transfer unit 9 here must transfer the motion of the control element 3 to the electromechanical unit 4, even though the axes of the two structural parts are, however, separate from one another. For this reason, the transfer must take place by means of further elements. For example, a spur-wheel gearing 10 may be provided for this movement. One of the spur wheels 10 is fastened for this purpose to the control unit 3; the other spur wheel 10 is attached to the shaft of the electromechanical unit 4. Both spur wheels 10 mesh with one another, so that, aside from the power transfer, translation of the rotational motion also results. Alternatively, further suitable transfer possibilities are provided to bridge the distance from the axes of the control element 3 to an electromagnetic unit 4.

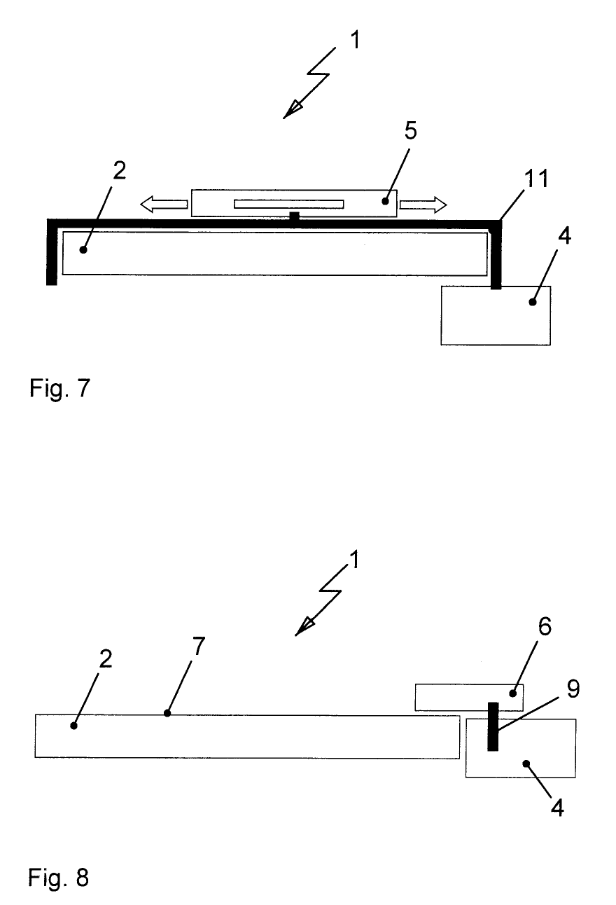

In FIG. 7, a control arrangement 1 is depicted which is made available through a sensor unit 5 horizontally movable relative to that of the screen 2. The sensor unit 5 is connected to the electromechanical unit 4 by means of the mechanical transfer unit 9. Through this combination, the horizontal motion of the control unit 3, which is executed as a sensor unit 5, is converted into electrical control signals.

The position of the sensor unit 5 is localizable by means of the screen 2. Position information thus follows from the amount of deflection of the positioning unit 11, which is converted into an electrical signal.

The content of the screen 2 is variable. With its touch-sensitive surface, it receives the pressure commands that are applied by the operator at the sensor element 5. In some instances, direct touch capabilities may also additionally exist

In FIG. 8, a side view of a control arrangement 1 is depicted, which corresponds to the control arrangement 1 shown in FIG. 4. The push buttons 6 are visible, which are connected by means of the mechanical transfer element 9 to the electromechanical unit 4. Thus the transfer results through the mechanical transfer element 9, which transfers the button pressure as a compressive force to the electromechanical unit 4.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A screen-based vehicle control system, characterized by the fact that the control arrangement (1) consists of a screen (2) and at least one mechanical control unit (3).

2. A screen-based vehicle control system according to claim 1, characterized by the fact that the screen (2) is executed as a touch-sensitive screen.

3. A screen-based vehicle control system according to claim 1, characterized by the fact that at least one control element (3) is disposed such that it projects in part up into the variable display field (7) of the screen (2) and covers it to that extent.

4. A screen-based vehicle control system according to claim 1, characterized by the fact that the variable display field (7) of the screen (2) is executed such that a scale can be represented adjoining the control unit (3).

5. A screen-based vehicle control system according to claim 3, characterized by the fact that the variable display field (7) of the screen (2) is executed such that a scale can be represented adjoining the control unit (3).

6. A screen-based vehicle control system according to claim 3, characterized by the fact that at least one control element (3) is executed as twist controls.

7. A screen-based vehicle control system according to claim 4, characterized by the fact that at least one control element (3) is executed as twist controls.

8. A screen-based vehicle control system according to claim 1, characterized by the fact that at least one control element (3) is executed as push buttons (6).

9. A screen-based vehicle control system according to claim 4, characterized by the fact that at least one control element (3) is executed as push buttons (6).

10. A screen-based vehicle control system according to claim 1, characterized by the fact that a mechanical transfer element (9) is so designed that the control unit (3) acts upon it at the electromechanical unit (4).

11. A screen-based vehicle control system according to claim 3, characterized by the fact that a mechanical transfer element (9) is so designed that the control unit (3) acts upon it at the electromechanical unit (4).

12. A screen-based vehicle control system according to claim 4, characterized by the fact that a mechanical transfer element (9) is so designed that the control unit (3) acts upon it at the electromechanical unit (4).

13. A screen-based vehicle control system according to claim 6, characterized by the fact that a mechanical transfer element (9) is so designed that the control unit (3) acts upon it at the electromechanical unit (4).

14. A screen-based vehicle control system according to claim 1, characterized by the fact that at least one control element (3) is executed as a sensor unit (5) with a positioning unit (11) and an electromechanical unit (4).

15. A screen-based vehicle control system according to claim 1, characterized by the fact that the screen (2) and the control unit (3) are designed such that they are provided with proximity sensors and lighting units, and illumination results when coming up close.

16. A screen-based vehicle control system according to claim 1, characterized by the fact that the screen (2) is executed in such a way that two contacts, by the user and by a control unit projecting up above the screen (2), can be recorded independently of one another.
